(19) United States
(12) Patent Application Publication
(10) Pub. No.: US 2020/0410088 A1
(43) Pub. Date: Dec. 31, 2020

(54) MICRO-INSTRUCTION CACHE ANNOTATIONS TO INDICATE SPECULATIVE SIDE-CHANNEL RISK CONDITION FOR READ INSTRUCTIONS

(71) Applicant: Arm Limited, Cambridge (GB)

(72) Inventors: Peter Richard GREENHALGH, Cambridge, Cambridgeshire (GB); Frederic Claude Marie PIRY, Cagnes Sur Mer, Alpes Maritimes (FR); Ian Michael CAULFIELD, Cambridge, Cambridgeshire (GB); Albin Pierrick TONNERRE, Nice (FR)

(21) Appl. No.: 16/976,185

(22) PCT Filed: Mar. 12, 2019
(86) PCT No.: PCT/GB2019/050675

§ 371 Date: Aug. 27, 2020

(30) Foreign Application Priority Data
Apr. 4, 2018 (GB) 1805487.4

(51) Int. Cl. G06F 21/52; G06F 12/0875; G06F 9/22

(52) U.S. Cl. CPC G06F 21/52; G06F 12/0875; G06F 2221/034; G06F 2212/452; G06F 9/223

(57) ABSTRACT

An apparatus (2) has processing circuitry to process micro-operations, the processing circuitry supporting speculative processing of read micro-operations for reading data from a memory system. A cache (6, 8) is provided to cache the micro-operations or instructions decoded to generate the micro-operations. Profiling circuitry (40) annotates at least one cached micro-operation or instruction with annotation information depending on analysis of whether a read micro-operation satisfies a speculative side-channel condition indicative of a risk of information leakage if the read micro-operation is processed speculatively. The processing circuitry (12, 14) determines whether to trigger a speculative side-channel mitigation measure depending on the annotation information stored in the cache (6, 8).

The present technique relates to the field of data processing.

A data processing apparatus may support speculative execution of instructions, in which instructions are executed before it is known whether input operands for the instruction are correct or whether the instruction needs to be executed at all. For example, a processing apparatus may have a branch predictor for predicting outcomes of branch instructions so that subsequent instructions can be fetched, decoded and executed speculatively before it is known what the real outcome of the branch should be. Also some systems may support load speculation where the value loaded from memory is predicted before the real value is actually returned from the memory, to allow subsequent instructions to be processed faster. Other forms of speculation are also possible.

At least some examples provide an apparatus comprising: processing circuitry to process micro-operations, the processing circuitry supporting speculative processing of read micro-operations for reading data from a memory system; a cache to cache the micro-operations or instructions decoded to generate the micro-operations; and profiling circuitry to annotate at least one cached micro-operation or instruction in the cache with annotation information depending on analysis of whether a read micro-operation satisfies a speculative side-channel condition indicative of a risk of information leakage if the read micro-operation is processed speculatively; in which: the processing circuitry is configured to determine whether to trigger a speculative side-channel mitigation measure depending on the annotation information stored in the cache.

At least some examples provide a data processing method comprising: processing micro-operations using processing circuitry supporting speculative processing of read micro-operations for reading data from a memory system; storing in a cache the micro-operations or instructions decoded to generate the micro-operations; and annotating at least one cached micro-operation or instruction in the cache with annotation information depending on analysis of whether a read micro-operation satisfies a speculative side-channel condition indicative of a risk of information leakage if the read micro-operation is processed speculatively; and determining whether to trigger a speculative side-channel mitigation measure depending on the annotation information stored in the cache.

Further aspects, features and advantages of the present technique will be apparent from the following description of examples, which is to be read in conjunction with the accompanying drawings, in which:

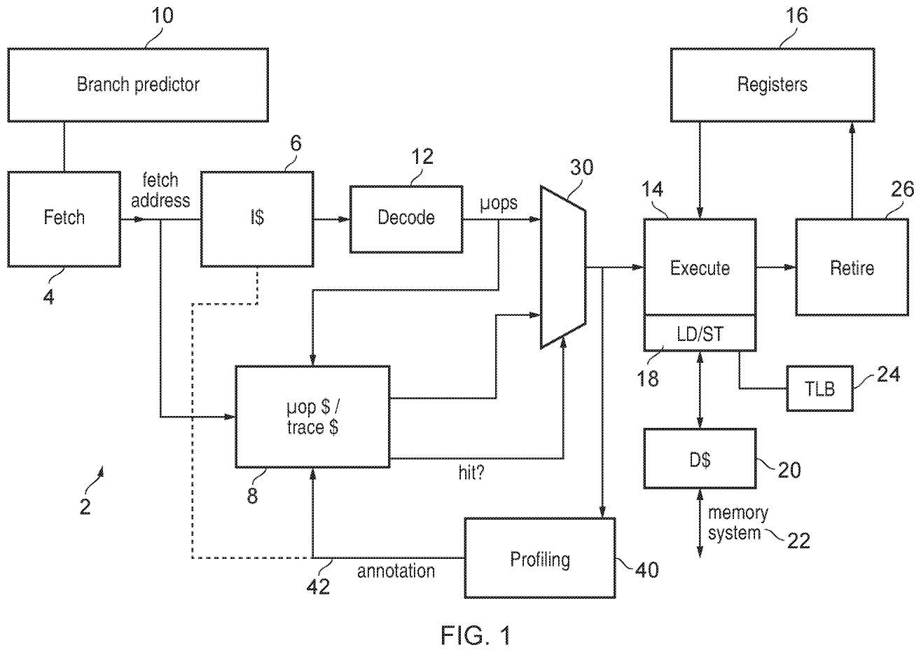

FIG. 1 schematically illustrates an example of a data processing apparatus;

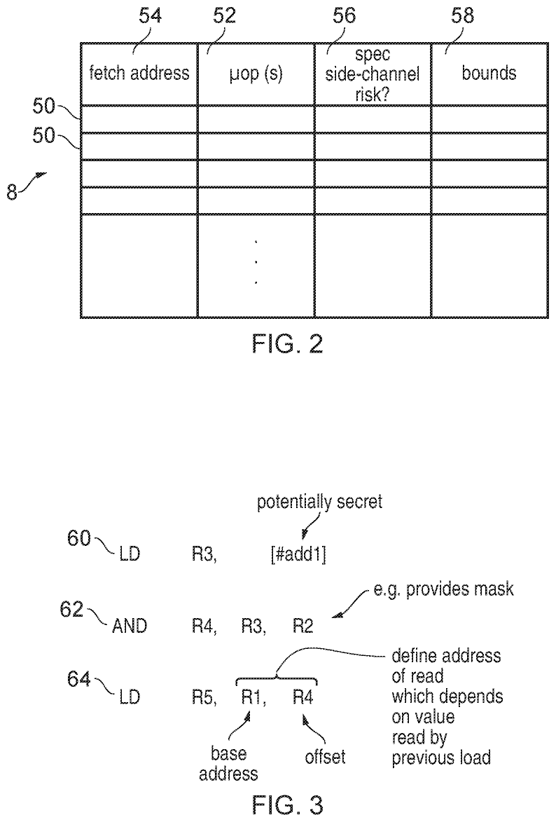

FIG. 2 illustrates an example of a micro-operation cache annotated with information indicating risk of speculation side-channel attacks;

FIG. 3 illustrates an example sequence of instructions where dependencies between successive read instructions indicate a potential risk of information leakage if the read micro-operations are processed speculatively; and

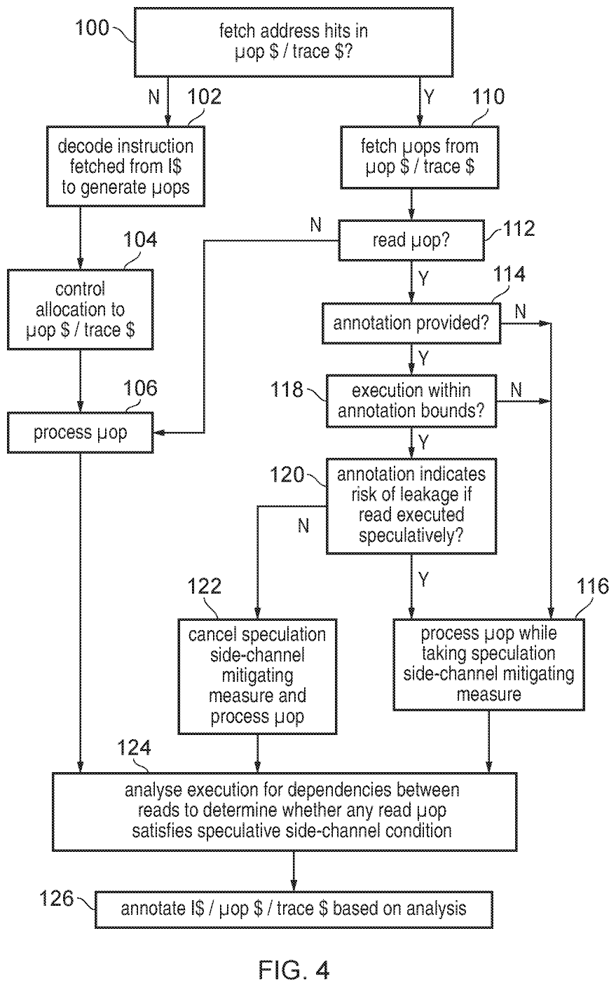

FIG. 4 is a flow diagram illustrating a method of determining whether to trigger a speculative side-channel mitigation measure depending on the annotation information stored in the cache.

A data processing apparatus may have mechanisms for ensuring that some data in memory cannot be accessed by certain processes executing on the processing circuitry. For example privilege-based mechanisms and/or memory protection attributes may be used to control the access to certain regions of memory. Recently, it has been recognised that in systems using speculative execution and data caching, there is a potential for a malicious person to gain information from a region of memory that they do not have access to, by exploiting the property that the effects of speculatively executed instructions may persist in a data cache even after any architectural effects of the speculatively executed instructions have been reversed following a misspeculation. Such attacks may train branch predictors or other speculation mechanisms to trick more privileged code into speculatively executing a sequence of instructions designed to make the privileged code access a pattern of memory addresses dependent on sensitive information, so that less privileged code which does not have access to that sensitive information can use cache timing side-channels to probe which addresses have been allocated to, or evicted from, the cache by the more privileged code, to give some information which could allow the sensitive information to be deduced. Such attacks can be referred to as speculative side-channel attacks.

A number of mitigation measures can be taken to reduce the risk of information leakage due to speculative side-channel attacks. Various examples of speculative side-channel mitigation measure are discussed in more detail below. However, in general the speculative side-channel mitigation measure may typically reduce processing performance compared to the performance achieved if the speculative side-channel mitigation measure was not taken. The inventors recognised that applying the speculative side-channel mitigation measure by default to all operations may unnecessarily sacrifice performance, because in practice it is only certain patterns of operations which may provide a risk of information leakage through side-channel attacks.

In the technique discussed below, processing circuitry for processing micro-operations, which supports speculative processing of read micro-operations for reading data from a memory system, may be provided with a cache for caching either the micro-operations themselves or instructions which are decoded to generate the micro-operations. Profiling circuitry may annotate at least one cached micro-operation or instruction in the cache with annotation information depending on analysis of whether a read micro-operation satisfies a speculative side-channel condition indicative of a risk of information leakage if the read micro-operation is processed speculatively. The processing circuitry can determine whether to trigger a speculative side-channel mitigation measure depending on the annotation stored in the cache.

Hence, the profiling circuitry can analyse the micro-operations to be processed in order to check whether they include any pattern of operations determined to cause a risk of information leakage through speculative side-channel attacks, or alternatively to identify patterns which can be guaranteed not to cause such a risk, and can annotate the cached micro-operations in the micro-operation or cached instructions in the instruction cache as safe or unsafe as required, so that the processing circuitry can select whether it is really necessary to take the speculative side-channel mitigation measure. This can allow more aggressive speculation or other performance improvements in cases where this is deemed to be safe. Hence, this can provide a better balance between performance and safety against speculative side-channel attacks.

In some implementations, it may be possible for the profiling circuitry to perform the analysis to evaluate the risk of side-channel attacks based on the instructions stored in memory which define the program code to be executed, irrespective of the outcome of such instructions when actually executed. However, in some cases this may result in a conservative estimation of the risk of speculative side-channel attacks, and in practice more information for evaluating the risk of these attacks may be available from the execute stage where the micro-operations corresponding to the program instructions are actually executed, as the risk could depend on the particular sequence in which the operations are executed (which could depend on data-dependent conditions which may not be known from the original program stored in memory), or could depend on other factors such as contents of translation lookaside buffers defining memory access permissions, or on the operation state in which the code is executed. Hence, in some examples the profiling circuitry may be arranged to analyse the micro-operations which were previously processed by the processing circuitry (e.g. based on the information derived from the execute stage of a processing pipeline) to determine the annotation information to be provided in the cache alongside micro-operations or instructions.

The profiling circuitry may determine whether the speculative side-channel condition is satisfied for a given read micro-operation depending on analysis of dependencies between read operations. In particular, the profiling circuitry may determine whether the speculative side-channel condition is satisfied for the read micro-operation depending on an analysis of whether the read micro-operation is one of: a control-dependent producer read micro-operation for which the target address of a subsequent read micro-operation is dependent on a data value read in response to the producer read micro-operation; and a control-dependent consumer read micro-operation for which the target address is dependent on a data value read by an earlier read micro-operation. This recognises that the speculative side-channel attacks are often based on the attacker tricking more privileged code into first executing a read micro-operation speculatively which accesses some secret information, and then executing a further read whose target address depends on the data value read by the earlier micro-operation. In this case, even if it is subsequently detected that the initial micro operation reading the secret should not have been executed due to a misspeculation, the second read may still have changed cache states based on an address dependent on the secret, and this can allow information about the secret to be leaked. Hence, if a given read micro-operation does not have any further read which depends on the value read from the memory system, then it can be established that the risk of speculative side-channel attacks is low. Hence for such reads the speculative side-channel mitigation measure may be unnecessary and can be omitted to improve performance.

The profiling circuitry may be arranged to check for such sequences of dependent reads in different ways to evaluate whether the speculative side-channel condition is satisfied. In some case the profiling circuitry may actually check for such sequences of dependent reads, e.g. to identify a control-dependent producer read and a control-dependent consumer read as discussed above, and when such a pattern is detected then may set annotation information to indicate that such reads involve a risk of the attack.

However, in other approaches it may not be always possible to ensure that potentially risky sequences of reads can be detected. For example, as the value read by one read micro-operation could then be processed by a sequence of subsequent arithmetic operations before the value is generated which is used to calculate the address of the current consumer read micro-operation, the profiling circuitry may need to track dependencies through a series of instructions in order to evaluate the risk of the speculative side-channel attacks. In practice, there may be a limit to the number of instructions for which the profiling circuitry can track the dependencies and so if no dependency has yet been spotted between reads by the time the limit of the hardware detection capability has been reached then the profiling circuitry may conservatively assume that there could still be a risk of the information leakage through speculative side-channel attacks. Hence, in some cases rather than checking for patterns of operations indicating that there is a risk of such attacks, the circuitry could instead check for patterns of operations which indicate that there is definitely no risk of attack. For example, the profiling circuitry could flag which registers contain either the value read by a producer read micro-operation or subsequent values calculated based on the value read by the producer read micro-operation, and when it is detected that all of such registers have been overwritten with other values independent of the producer read, then it can be safely determined that there will be no consumer reads which could calculate its target address based on the data value read by the earlier read micro-operation, and so in this case the profiling circuitry could determine that it is safe to annotate the earlier read micro-operation (or an instruction corresponding to the earlier read micro-operation) as not requiring the speculation side-channel mitigation measure.

Hence in some cases the profiling circuitry may assume that the speculative side-channel condition is satisfied for a read micro-operation (i.e. there is a risk of information leakage by speculative side-channel attacks if the read was executed speculatively), unless the profiling circuitry determines that the read micro-operation is neither the control-dependent producer read micro-operation (whose read data value is used to generate the target address of a subsequent read) nor the control-dependent consumer read micro-operation (whose target is address depends on a data value read for an earlier read micro-operation). If it cannot be established that the read micro-operation is not such a control-dependent producer/consumer read, then in other cases the read may be assumed to satisfy the speculative side-channel condition as a precaution (even if actually the read would not behave as such a control-dependent producer/consumer read).

Hence, it will be appreciated that the annotations could be implemented in different ways. In some cases the annotations may be applied to the safe instructions which have been identified as not causing a risk of information leakage if executed speculatively. In other approaches the annotations may be applied to the unsafe instructions deemed to cause a risk of information leakage if executed speculatively, with the safe instructions taking a default value for the annotation.

In some examples, the dependency between reads may be the sole factor used to evaluate whether the speculative side-channel condition is satisfied for a given read micro-operation.

However, in other cases some additional information derived from analysis of previous processing of the read micro-operation may be used by the profiling circuitry to determine whether the speculative side-channel is satisfied. For example, the additional information could comprise an operating state in which the read micro-operation is executed. For example, if a given read micro-operation is executed in the least privileged operating state provided by the processing circuitry, which has the most restricted access to memory, then it may be assumed that any secret information could not have been accessed by that read micro-operation and so it may be safe to execute that read speculatively.

Another example may be that the additional information may comprise memory access permission specified for a target address of the read micro-operation. For example, if it has been established that on a previous execution the target address of a given read had memory access permissions defined for it that permit the corresponding address to be accessed by any operating state of the processing circuitry, then again there may be no need for security measures as the attacker would be allowed to access such a memory location anyway and there is no risk of leakage of secret information which is only accessible to some operating states.

Hence, by considering additional information, such as one or both of the operating state and the memory access permission information, the profiling circuitry can make more precise predictions of whether it is safe to execute a given read speculatively without the speculation side-channel mitigation measure, to avoid unnecessary performance loss by conservatively assuming that the mitigation measure is required when in fact it is not really needed. Nevertheless, there may be a balance between the performance improvements achieved by enabling the mitigation measure when safe to do so and the added complexity of the profiling circuitry in order to consider additional pieces of information, and so some system designers may choose to implement a simpler profiling circuitry which considers a more limited set of information.

The annotations indicating whether a given read incurs a risk of information leakage through speculation side-channels may be applied to different reads in a sequence of reads. In some cases, the annotation could be applied to the producer read micro-operation discussed above, whose return data value is used to generate the target address of the subsequent read. In this case it may not be necessary to separately annotate the subsequent read as well, as by indicating that there is a risk of attack for the producer read then the appropriate precautions could be taken to mitigate such attacks. Alternatively, other approaches may set the annotation for a given read micro-operation to indicate whether the read is the consumer read micro-operation whose target address depends on a data value read by an earlier read micro-operation, and may choose not to annotate the corresponding producer micro-operation which supplied the data value used to calculate the target address of the consumer read.

Alternatively, other approaches could apply annotation information to micro-operations or instructions which do not trigger a read at all, rather than applying the annotations to the producer or consumer reads as discussed above. For example, a block based approach could be used where the first micro-operation or instruction in a given block is annotated to indicate whether the subsequent operations of that block contain any read micro-operation which satisfied the speculative side-channel position, and then when starting to process instructions from a block annotated as incurring a risk of information leakage than the speculation side-channel mitigation measure could be taken for the remaining micro-operations or instructions of that block, whereas the mitigation measure can be omitted if that annotation at the start of a block of annotations indicates that there is no risk. This approach could be particularly useful for a trace cache which may indicate consecutive sequences of micro-operations in the precise order in which they are then executed by the processing circuitry. For example, the annotation could indicate whether any micro-operation in a single trace entry providing a sequence of contiguously executed operations posed a risk of information leakage through side-channel attacks if executed speculatively.

In some implementations, the annotation information could comprise additional annotation bounds information indicating a limit of validity of the annotation information. In this case, when a given micro-operation associated with the annotation information is processed outside the limits of validity indicated by the annotation bounds information, the processing circuitry may trigger the speculation side-channel mitigation measure regardless of whether the corresponding annotation information specifies that the speculation side-channel mitigation measure should be triggered for the given micro-operation. For example, the annotation bounds information may indicate a subset of operating states of the processing circuitry in which the annotation information is considered valid, or could specify an address range for which the annotation information is valid. If a given read operation is executed within the limits of validity indicated by the annotation bounds, then the annotation information may be treated as valid and the determination of whether to trigger the speculation side-channel mitigation measure can be made based on the annotation information. However, if a read micro-operation is encountered outside the bounds of validity then the speculation side-channel mitigation measure may be triggered regardless of the annotation information as in this case the annotation information may not be trusted. This recognises that in some cases on a previous instance of execution of a micro-operation the profiling circuitry could have determined that the speculative read was in principle safe, for example because the memory permission set for the corresponding address or the current operating state of the processing circuitry was deemed not to be of risk. However, if later the same instruction is executed using a different target address outside the previously evaluated address range or in a different operating state, then this may change the risk of speculation side-channel attacks and so the previous determination may no longer be valid. Hence by establishing bounds of validity on the annotation information, this can reduce the risk of attacks.

At least one of the cache and the profiling circuitry may be responsive to an annotation cancelling event to cancel previously determined annotation information associated with the at least one cached micro-operation or instruction. For example, the annotation cancelling event could be a TLB invalidation or resetting of page tables which signals that memory access permissions for regions of memory have changed, which could indicate that any assumptions made based on previous contents of the page tables may no longer be valid and so the annotations already allocated to the cache should be flushed in order to avoid potentially unsafe assumptions that there is no risk of attack for certain reads. Another example of an annotation cancelling event could be a context switch where the processing circuitry switches from executing code associated with one process to another, at which point the risk evaluation made for the previous context may no longer be valid for the next context.

A number of different forms of speculative side-channel mitigation measure can be used to guard against potential speculative side-channel attacks. Any of the following examples may be used, either individually or in combination.

In one example, the speculative side-channel mitigation measure may comprise disabling speculative execution of read micro-operations. This ensures that an attacker cannot use a misspeculation, such as a branch prediction or load value misprediction, as a means to cause more privileged code to execute an instruction to load secret information which should not have been executed.

Another example of a speculative side-channel mitigation measure may be to reduce a maximum number of micro-operations which can be executed speculatively beyond the youngest resolved non speculative micro-operation. By performing less aggressive speculation this can reduce the window of operation for an attacker to change cache state based on a read access to an address derived from an incorrectly loaded secret value.

Another example of the mitigation measure may be to insert, into a sequence of micro-operations to be processed by the processing circuitry, a speculation barrier micro-operation for controlling the processing circuitry to disable speculative processing of micro-operations after the speculation barrier micro-operation until any micro-operations preceding the speculation barrier micro-operation have been resolved. For example the barrier may be inserted between the producer and consumer instructions as discussed above in order to ensure that the consumer operation will not be executed until it is sure that the producer micro-operation was correct.

Another approach to mitigate against the side-channel attacks may simply be to slow or halt processing of micro-operations by the processing circuitry for a period. By slowing the pipeline, this effectively reduces the number of micro-operations which will be executed speculatively before an earlier micro-operation is resolved, again effectively reducing the window of opportunity for the attacker to gain information from incorrectly read secret data.

Other approaches to mitigate against speculative side-channel attacks may focus not on the speculation, but on data caching of the data loaded by the speculative read operations. For example, the speculative side-channel mitigation measure could be that values loaded in response to a speculative read are not cached or are placed in a temporary buffer or speculative region of a cache which is flushed upon a misspeculation and is only allowed to influence the main non speculative cache data if the speculation is determined to be correct. Also the speculative side-channel mitigation measure could comprise flushing or invalidating at least a portion of a data cache for caching data read in response to speculative read micro-operations. These mitigations may focus not on reducing the aggressiveness of speculation, but on whether the effects of such speculations are visible to other operations, which can again mitigate against the ability of the attacker to use cache timing side-channels in order to probe what data was loaded speculatively.

It will be appreciated that these are just some of the potential mitigations which could be taken. In general the annotations in the cache discussed above could be used to control whether it is necessary to perform any step taken to reduce the risk of an attack based on speculatively executed read operations and use of cache timing measurements to probe what data was speculatively loaded.

The cache which was annotated based on the evaluation of risk by the profiling circuitry could be one of a number of different types of cache used to cache instructions or micro-operations for processing by the processing circuitry. Note that this cache is different to the data cache which may cache the data read from memory based on read micro-operations.

In one example, the cache may comprise an instruction cache which caches the instructions to be decoded in order to generate the micro-operations to be processed by the processing circuitry.

In another example the cache may comprise a micro operation cache which caches micro-operations generated by decoding of instructions. The micro-operation cache can provide more opportunity for annotation based on properties of execution, since it may reflect more accurately the form in which the instructions are decoded (e.g. as the micro-operation cache may support fusion of micro-operations generated from decoding of different program instructions into a single micro-operation to be processed by the downstream portions of the pipeline). The micro-operation cache may also include micro-operations which are split from a single program instruction into multiple micro-operations.

Another form of cache which could be annotated with information identifying the risk of speculative side-channels may be a trace cache for caching sequences of micro-operations indicative of an order in which the micro-operations were previously processed by the processing circuitry. While the micro-operation may cache individual micro-operations which can then be fetched in sequence based on the latest fetch address of the next instruction to be executed, in the trace cache, larger sequences of micro-operations may be cached in sequence and then a single fetch of the entire sequence may be used to fill the pipeline without needing to individually step through the sequence predicting the next fetch address after each individual micro-operation of the sequence. Again, the trace cache can be annotated with information identifying the risk of side-channel attacks for the corresponding sequence of micro-operations.

FIG. 1 schematically illustrates an example of a data processing apparatus 2 having a processing pipeline for processing instructions of a program to carry out processing operations. The pipeline includes a fetch stage 4 for identifying the address of the next instruction to be processed in the program flow, which is output as a fetch address to an instruction cache 6 and to a micro-operation cache or trace cache 8. The fetch stage 4 may determine a fetch address based on a branch predictor 10 for predicting outcomes of branch instructions. The instruction cache 6 caches instructions in the same form as which the instructions are defined in the program code stored in memory. Instructions from the instruction cache 6 are provided to a decode stage 12 where the instructions are decoded into micro-operations (μops or uops) to be executed by an execute stage 14. Some program instructions may map to a single micro-operation, while other program instructions may map to multiple separate micro-operations each corresponding to part of the functionality of the program instruction. For example, a load/store micro-operation for reading data from memory or storing data to memory could be split into an address generation micro-operation for calculating the address of the load or store and a data access micro-operation for actually triggering the access to the memory system based on the calculated address. Another example can be an arithmetic operation which could be represented by a single program instruction in memory but may be decomposed into a number of simpler micro-operations for processing separately by the execute stage 14.

The execute stage 14 may include a number of execution units for processing different types of micro-operation, for example an arithmetic/logical unit (ALU) for processing arithmetic or logical micro-operations based on integer operands read from registers 16, a floating point unit for performing operations on floating points operands read from the registers, and/or a vector processing unit for performing vector processing operations which use operands from the register 16 which specify a number of independent data values within the same register. One of the execute units of the execute stage 14 may be a load/store unit 18 for processing read operations to read data from a data cache 20 or memory system 22 (which could include further caches and main memory) and write operations to write data to the data cache 20 or memory system 22. The load/store unit may use page table entries within a translation lookaside buffer (TLB) 24 to determine whether, in a current execution state, the processor is allowed to access the region of memory identified by a target address of a read or write (load or store) operation. For example the TLB may restrict access to certain memory regions to certain modes or privilege levels of the processor.

Instructions executed by the execute stage 14 are retired by a retire (or write back) stage 26, where the results of the instructions are written back to the register 16. The processing pipeline may support speculative execution of micro-operations, for example based on predictions made by the branch predictor 10 or other speculative elements such as data prefetchers or load value predictors, and so the retire stage 26 may also be responsible for evaluating whether predictions have been made correctly and may trigger results of speculatively executed operations to be discarded in the event of a misprediction. Following a misprediction, incorrectly speculated instructions can be flushed from the pipeline, and execution can resume from the last correct execution point before the incorrect prediction was made.

The micro-operation cache or trace cache 8 may be provided to speed up processing and save power by eliminating the need to invoke the decode stage 12 as often. Hence, the micro-operations, which are decoded by the decode stage 12 based on program instructions from the instruction cache 6 or fused from multiple separate decoded micro-operations, can be cached in the micro-operation cache or trace cache 8 for access when program execution reaches a corresponding fetch address again in future. The micro-operation cache 8, if provided, may cache micro-operations without regard to the sequence in which they are executed. For example the micro-operation cache may have a number of entries which are tagged based on the fetch address of the instruction corresponding to that micro-operation. Hence, in parallel with inputting the fetch address into the instruction cache 6, the fetch address can also be supplied to the micro-operation cache, and if there is a hit in the micro-operation cache then this may control a multiplexer 30 to select a micro-operation output by the micro-operation cache instead of the micro-operation decoded by the decode stage 12. Also a signal from the micro-operation cache may be used to place at least part of the decode stage 12 in a power saving state when there is a hit in the micro-operation cache.

If provided, a trace cache may operate in a similar way to the micro-operation cache, except that the trace cache may not only cache the micro-operations themselves, but may also track a sequence in which those micro-operations were actually executed by the execute stage 14. For example, a trace of executed micro-operations may include successive branch operations and may string together different blocks of micro-operations which were executed between the branches so as to provide a single entry in the trace which can be fetched as a contiguous block of operations for execution by the execute stage 14, without the fetch stage 4 needing to individually recalculate each successive fetch address in response to each of the processed micro-operations. Also, whereas the micro-operation cache may cache speculatively executed micro-operations which may then subsequently turn out to have been incorrect, the trace cache 8 may cache the correctly executed sequences of micro-operations (traces corresponding to incorrectly speculated operations may be invalidated). It will be appreciated that some systems could have only one of a micro operation cache and a trace cache while other systems may have both.

One benefit of providing the micro-operation cache or the trace cache is this can permit further performance optimisations by fusing multiple micro-operations decoded by the decode stage 12 in response to separate program instructions into a single common micro-operation, if the processing units in the execute stage 14 support processing a combined micro-operation. By fusing micro-operations when possible then this reduces the amount of pipeline utilisation required for that operation, freeing up pipeline slots for executing other operations, which can help to improve performance.

Speculation-based cache timing side-channels using speculative memory reads have recently been proposed. Speculative memory reads are typical of advanced microprocessors and part of the overall functionality which enables very high performance. By performing speculative memory reads to cacheable locations beyond an architecturally unresolved branch (or other change in program flow), and, further, using the result of those reads themselves to form the addresses of further speculative memory reads, these speculative reads cause allocations of entries into the cache whose addresses are indicative of the values of the first speculative read. This becomes an exploitable side-channel if untrusted code is able to control the speculation in such a way it causes a first speculative read of location which would not otherwise be accessible at that untrusted code, but the effects of the second speculative allocation within the caches can be measured by that untrusted code.

For any form of supervisory software, it is common for untrusted software to pass a data value to be used as an offset into an array or similar structure that will be accessed by the trusted software. For example, an application (untrusted) may ask for information about an open file, based on the file descriptor ID. Of course, the supervisory software will check that the offset is within a suitable range before its use, so the software for such a paradigm could be written in the form:

1 struct array {
2 unsigned long length;
3 unsigned char data[ ];
4};
5 struct array *arr= . . . ;
6 unsigned long untrusted_offset_from_user= . . . ;
7 if (untrusted_offset_from_user<arr->length) {
8 unsigned char value;
9 value=arr->data[untrusted_offset_from_user];
10 . . .
11}

In a modern micro-processor, the processor implementation commonly might perform the data access (implied by line 9 in the code above) speculatively to establish value before executing the branch that is associated with the untrusted_offset_from_user range check (implied by line 7). A processor running this code at a supervisory level (such as an OS Kernel or Hypervisor) can speculatively load from anywhere in Normal memory accessible to that supervisory level, determined by an out-of-range value for the untrusted_offset_from_user passed by the untrusted software. This is not a problem architecturally, as if the speculation is incorrect, then the value loaded will be discarded by the hardware.

However, advanced processors can use the values that have been speculatively loaded for further speculation. It is this further speculation that is exploited by the speculation-based cache timing side-channels. For example, the previous example might be extended to be of the following form:

1 struct array {
2 unsigned long length;
3 unsigned char data[ ];
4};
5 struct array *arr1= . . . ; /* small array */
6 struct array *arr2= . . . ; /*array of size 0x400 */
7 unsigned long untrusted_offset_from_user= . . . ;
8 if (untrusted_offset_from_user<arr1->length) {
9 unsigned char value;
10 value=arr1->data[untrusted_offset_from_user];
11 unsigned long index2=((value&1)*0x100)+0x200;
12 if (index2<arr2->length) {
13 unsigned char value2=arr2->data[index2];
14}
15}

In this example, “value”, which is loaded from memory using an address calculated from arr1->data combined with the untrusted_offset_from_user (line 10), is then used as the basis of a further memory access (line 13). Therefore, the speculative load of value2 comes from an address that is derived from the data speculatively loaded for value. If the speculative load of value2 by the processor causes an allocation into the cache, then part of the address of that load can be inferred using standard cache timing side-channels. Since that address depends on data in value, then part of the data of value can be inferred using the side-channel.

By applying this approach to different bits of value, (in a number of speculative executions) the entirety of the data of value can be determined. Hence, the untrusted software can, by providing out-of-range quantities for untrusted_offset_from_user, access anywhere accessible to the supervisory software, and as such, this approach can be used by untrusted software to recover the value of any memory accessible by the supervisory software.

Modern processors have multiple different types of caching, including instruction caches, data caches and branch prediction cache. Where the allocation of entries in these caches is determined by the value of any part of some data that has been loaded based on untrusted input, then in principle this side channel could be stimulated.

As a generalization of this mechanism, it should be appreciated that the underlying hardware techniques mean that code past a branch might be speculatively executed, and so any sequence accessing memory after a branch may be executed speculatively. In such speculation, where one value speculatively loaded is then used to construct an address for a second load or indirect branch that can also be performed speculatively, that second load or indirect branch can leave an indication of the value loaded by the first speculative load in a way that could be read using a timing analysis of the cache by code that would otherwise not be able to read that value. This generalization implies that many code sequences commonly generated will leak information into the pattern of cache allocations that could be read by other, less privileged software. The most severe form of this issue is that described earlier in this section, where the less privileged software is able to select what values are leaked in this way.

Hence, it may be desirable to provide counter-measures against this type of attack. A number of mitigation measures could be used. For example, read operations for reading data from the data cache 20 or memory system 22 could be prevented from being performed speculatively, or speculation could be applied less aggressively by slowing down the pipeline or reducing the number of instructions which can be executed speculatively while waiting for an earlier instruction to be resolved, which can reduce the window of opportunity for an attacker to exploit the type of attack discussed above. Other approaches can provide a speculation barrier instruction which can be inserted when a number of control-dependent read operations are detected, to separate the consumer read which has its target address calculated based on an earlier data value read from memory from the producer read which reads that data value from memory, with the barrier instruction instructing the pipeline that it cannot speculatively execute the second read while the first read remains speculative. This ensures that if the first read should never have been executed, then the barrier ensures that it will be cancelled before the second read is encountered. Other approaches can be taken to reduce the effect on cache state by incorrectly speculatively executed read operations. For example, the data cache 20 could be split into a main cache region used for non-speculative data and a speculative cache region used for data read in response to speculatively executed read operations while the read remains speculative. The data may be promoted to the main region when the speculation has been resolved as correct and the contents of the speculative region could be discarded when an event indicating an increased risk of attack is identified, such as switching to a less privileged mode of execution. Also, in some cases additional cache flushes may be performed to invalidate at least speculatively read data from the cache when a pattern of operations deemed at risk of attack is detected.

A common factor between any of these mitigation measures is that they tend to reduce the performance achieved by the processor as they either mean that instructions which could have been executed speculatively are held back or that additional cache misses are incurred for some subsequent read operations to delay those reads and any operations dependent on those reads. While such mitigation measures can be effective at preventing the attacks, they may unnecessarily harm performance for some program code which does not contain a pattern of operations which could be used to trigger the side-channel attack.

As shown in FIG. 1, the apparatus 2 may have profiling circuitry 40 which analyses the micro-operations processed by the execute stage 14 to determine whether any read micro-operation processed by the execute stage 14 satisfies a speculative side-channel condition indicative of a risk of information leakage if the read micro-operation is processed speculatively. Based on this analysis, the profiling circuitry 40 may then supply annotations 42 to the micro-operation cache or trace cache 8, or to the instruction cache 6, to indicate whether the corresponding operations involve a risk of such side-channel attacks. Some cached instructions or micro-operations are tagged with the annotation supplied by the profiling circuitry, and the data processing apparatus 2 may then use such annotations to evaluate whether it is necessary to perform the speculative side-channel mitigation measure. Hence, for those operations which are not deemed to be of risk of invoking the attacks, the mitigation measure can be cancelled so as to allow more aggressive speculation in the case of sequences of operations where the aggressive speculation is safe.

FIG. 2 shows an example of the micro-operation cache annotated with such annotation information. For example, each entry 50 of the micro-operation cache may specify one or more micro-operations 52, a tag 54 specifying the fetch address or a part of the fetch address 54 which identifies the point of the program to which the micro-operation(s) corresponds. In addition, each entry 50 may specify a speculation side-channel risk annotation 56 which indicates whether or not individual micro-operations are at risk of invoking the side-channel, and optionally annotation bounds information 58 defining a limit of validity of the risk annotation 56. For example the bounds 58 could define a subset of operating states of the processing circuitry (e.g. a subset of exception levels or privilege levels) in which the annotation 56 can be trusted, and/or a limited read address range within which the annotation can be treated as valid. The annotation 56 could be specified only for read micro-operations or could be specified for other micro-operations to indicate whether a number of subsequent micro-operations contain a read at risk of invoking the side-channel. The annotation could flag the instructions which are at risk of information leakage through speculative side-channel attacks, or could flag the safe instructions which are deemed to be not at risk.

FIG. 3 shows an example of a sequence of operations which could be deemed to have a risk of information leakage through speculative side-channel attacks. This sequence of instructions includes a consumer read operation 60 which reads a data value from a given address #add1 and stores the read data value in register R3. The data value at #add1 could potentially be a secret value which is not accessible to some processes executing on the processor 2. This is followed by one or more intermediate instructions 62 for calculating a value based on the loaded data value, for example an AND instruction which combines the loaded value with a mask defined in register R2 to set an index value in destination register R4. In some cases, multiple separate instructions may generate the index value from the loaded data value. Subsequently, a consumer load 64 takes the index specified in register R4 and uses this as an offset to combine with a base address in register R1, to obtain the address of a subsequent read operation which reads a data value from memory and places it in a destination register R5.

Hence, this sequence comprises a consumer load 64 whose target address depends on the value read by an earlier load 60. Hence, if the producer load is incorrectly speculated then even if this misspeculation is detected later by the time the consumer load has been executed, the effects of the consumer load 64 on the data cache 20 may still be visible to an attacker who did not have access to the secret data loaded by the producer load 60.

In some cases the profiling circuitry 40 may seek to identify sequences of operations of the form shown in FIG. 3, with a pair of producer and consumer loads which are linked by a control dependency such that the value read by the producer load is used to generate the target address of the consumer load. However, in other cases the profiling circuitry 40 may look for sequences of operations which indicate that there definitely cannot be such a control dependency between loads, and may assume that there is a risk of side-channel attacks in all cases other than if such a safe set of operations is identified. For example, after a given read operation, the profiling circuitry 40 could track when the destination register of the read and any destination registers of subsequent operations which depend on the read value are overwritten with values independent of the read data, and if it is detected that there are no remaining registers storing values dependent on the previous read before any subsequent read has used the read-dependent data to derive its address, then it can be detected that the previous read is safe.

In some cases the profiling circuitry 40 could, in addition to dependencies between successive reads, also consider other information in generating the annotation information. For example, the profiling circuitry 40 could consider the contents of the page table entry accessed from the TLB 24 in response to a given read, which could give information on whether the memory access permissions for the read indicate that there is a risk of potential information leakage. For example, if a given read is determined to target a region of memory accessible to all privilege levels, the risk of attack for such a read is low as the read data would not be considered secret. Also, the profiling circuitry 40 could consider the privilege level or operating state in which a given read was executed. For example, reads executed in the least privileged state could be considered safe as again such reads would not be able to access sensitive data restricted for access to more privileged states.

FIG. 4 illustrates a method for processing micro-operations using the pipeline. At step 100 the next fetch address representing the current point reached in the program is input to the instruction cache 6 and micro-operation cache or trace cache 8. It is determined whether the fetch address hits in the micro-operation cache or trace cache 8. If not, then at step 102 an instruction fetched from the instruction cache corresponding to the next fetch address is decoded by the decode stage 12 to generate one or more micro-operations. At step 104 the micro-operation cache or trace cache 8 may be allocated with the decoded micro-operations (in the case of the trace cache, the allocation could be made later when the micro-operation is actually executed, or alternatively the decoded micro-operations could be allocated speculatively but then invalidated if it later turns out that some micro-operations should not be processed). At step 106 the decoded micro-operations are processed by the execute stage 14.

On the other hand, if the fetch address did hit in the micro-operation cache or the trace cache 8, then at step 110 the corresponding micro-operations are fetched from the micro-operation cache or trace cache 8 and are supplied for processing by the execute stage 14. In the case of the micro-operation cache, this could be one micro-operation or a relatively small number of micro-operations that corresponded to one program instruction represented by the fetch address. In the case of the trace cache the read micro-operations could comprise a longer sequence of micro-operations which may correspond to a series of decoded program instructions which were previously executed contiguously by the execute stage 14. At step 112 it is determined whether any of the fetched micro-operations include a read micro-operation for reading data from the data cache 20 or memory system 22. If there are no read micro-operations to be executed in the currently fetched group of micro-operations then the method proceeds to step 106 to process the fetched micro-operations. There is no need to consider whether to invoke the speculation side-channel mitigation measure when there are no reads being processed, although in some cases, when there are no reads then any previously invoked speculation side-channel mitigation measure may still be ongoing. Hence in some cases non-read micro-operations may result in no change to whether or not the speculation side-channel mitigation measure is being performed by the processing pipeline.

If at step 112 it is determined that a read micro-operation has been fetched, then at step 114 it is determined by the processing circuitry whether any annotation has been provided in the micro-operation cache or trace cache 8. If not, then at step 116 the read micro-operation is processed while taking the speculation side-channel mitigating measure. That is, when no annotation has been provided and it cannot be guaranteed that the read micro-operation can be safely speculated without risking information leakage, a mitigation measure can be taken, e.g. reducing aggression of speculation or disabling speculation for this operation, or changing the cache allocation policy to reduce the opportunity for attackers to probe the cache allocation in response to the speculative reads.

If an annotation is provided for the read micro-operation (note that this annotation need not have to explicitly correspond to the cache entry corresponding to the read micro-operation but could also be derived from an earlier operation such as the first micro-operation of a block including the read), then at step 118 the processing circuitry determines whether the current execution is within any annotation bounds 58 defined for the read micro-operation. For example if the target address of the read is not within an address range specified in the bounds 58, or the processor is not in one of the permitted execution states specified by the bounds 58, then at step 116 the micro-operation is processed while taking the speculation side-channel mitigating measure.

If the execution is within the annotation bounds defined for the read micro-operation then at step 120 it is determined whether the annotation indicates that there is a risk of leakage if the read is executed speculatively. If so then again the method proceeds to step 116 to ensure that the mitigating measure is taken. If the annotation indicates that there is no risk of leakage if the read is executed speculatively (e.g. because the data value loaded by the read operation has been determined to be independent of the calculation of any subsequent address, or because the address of the read is independent of any previously loaded value) then at step 122 the speculation side-channel mitigation measure can be cancelled and the micro-operation is processed without such a mitigation measure. Hence this can allow more aggressive speculation for this micro-operation and/or more efficient caching without worrying whether changes to the cache state could become visible to an attacker. This enables performance to be improved when safe to do so.

Regardless of whether the micro-operation was processed at step 106, 122 or 116, at step 124 the profiling circuitry 40 analyses the execution of micro-operations by the execute stage 14 for dependencies between read micro-operations, to determine whether any read micro operation satisfies a speculative side-channel condition indicating that there could be a risk of information leakage through speculative side-channel attacks. For example this can be based not only on tracking the dependencies through successive instructions but also on additional information such as TLB states and the current operating mode of the processor for example. Based on the analysis at step 124, at step 126 the profiling circuitry may annotate selected instructions or micro-operations in the instruction cache 6 or micro-operation or trace cache 8, to indicate which instructions may be safe to execute speculatively without taking the mitigation measure performed at step 116.

Although not shown in FIG. 4 for conciseness, in embodiments which annotate instructions in the instruction cache, steps corresponding to steps 112-122 may also be performed when an instruction from the instruction cache 6 is decoded at step 102, to control whether the speculation side-channel mitigating measure is performed based on the annotation associated with the cached instruction.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. An apparatus comprising:
processing circuitry to process micro-operations, the processing circuitry supporting speculative processing of read micro-operations for reading data from a memory system;
a cache to cache the micro-operations or instructions decoded to generate the micro-operations; and
profiling circuitry to annotate at least one cached micro-operation or instruction in the cache with annotation information depending on analysis of whether a read micro-operation satisfies a speculative side-channel condition indicative of a risk of information leakage if the read micro-operation is processed speculatively; in which:
the processing circuitry is configured to determine whether to trigger a speculative side-channel mitigation measure depending on the annotation information stored in the cache.

2. The apparatus according to claim 1, in which the profiling circuitry is configured to analyse micro-operations previously processed by the processing circuitry to determine the annotation information.

3. The apparatus according to claim 1, in which the profiling circuitry is configured to determine whether the speculative side-channel condition is satisfied for the read micro-operation depending on analysis of dependencies between read micro-operations.

4. The apparatus according to claim 3, in which the profiling circuitry is configured to determine whether the speculative side-channel condition is satisfied for the read micro-operation depending on both the analysis of dependencies and additional information derived from analysis of previous processing of the read micro-operation by the processing circuitry.

5. The apparatus according to claim 4, in which the additional information comprises at least one of:
an operating state in which the read micro-operation is executed; and
memory access permission information specified for a target address of the read micro-operation.

6. The apparatus according to claim 1, in which the profiling circuitry is configured to determine whether the speculative side-channel condition is satisfied for the read micro-operation depending on analysis of whether the read micro-operation is one of:
a control-dependent producer read micro-operation for which the target address of a subsequent read micro-operation is dependent on a data value read in response to the producer read micro-operation; and
a control-dependent consumer read micro-operation for which the target address is dependent on a data value read by an earlier read micro-operation.

7. The apparatus according to claim 6, in which the profiling circuitry is configured to assume that the speculative side-channel condition is not satisfied unless the profiling circuitry determines that the read micro-operation is neither said control-dependent producer read micro-operation nor said control-dependent consumer read micro-operation.

8. The apparatus according to claim 1, in which the profiling circuitry is configured to set an annotation associated with a micro-operation or instruction corresponding to a given read micro-operation to indicate whether the given read micro-operation is a control-dependent producer read micro-operation for which the target address of a subsequent read micro-operation is dependent on a data value read in response to the producer read micro-operation.

9. The apparatus according to claim 1, in which the profiling circuitry is configured to set an annotation associated with a micro-operation or instruction corresponding to a given read micro-operation to indicate whether the given read micro-operation is a control-dependent consumer read micro-operation for which the target address is dependent on a data value read by an earlier read micro-operation.

10. The apparatus according to claim 1, in which the annotation information comprises annotation bounds information indicating a limit of validity of the annotation information.

11. The apparatus according to claim 10, in which when a given micro-operation associated with annotation information is processed outside the limit of validity indicated by the annotation bounds information, the processing circuitry is configured to trigger the speculation side-channel mitigation measure regardless of whether the annotation information specifies that the speculation side-channel mitigation measure should be triggered for the given micro-operation.

12. The apparatus according to claim 10, in which the annotation bounds information specifies a subset of operating states of the processing circuitry in which the annotation information is valid.

13. The apparatus according to claim 10, in which the annotation bounds information specifies an address range for which the annotation information is valid.

14. The apparatus according to claim 1, in which the at least one of the cache and the profiling circuitry is responsive to an annotation cancelling event to cancel previously determined annotation information associated with the at least one cached micro-operation or instruction.

15. The apparatus according to claim 1, in which the speculative side-channel mitigation measure comprises disabling speculative execution of read micro-operations.

16. The apparatus according to claim 1, in which the speculative side-channel mitigation measure comprises reducing a maximum number of micro-operations which can be executed speculatively beyond the youngest resolved non-speculative micro-operation.

17. The apparatus according to claim 1, in which the speculative side-channel mitigation measure comprises inserting, into a sequence of micro-operations to be processed by the processing circuitry, a speculation barrier micro-operation for controlling the processing circuitry to disable speculative processing of micro-operations after the speculation barrier micro-operation until any micro-operations preceding the speculation barrier micro-operation have been resolved.

18. The apparatus according to claim 1, in which the speculative side-channel mitigation measure comprises:
slowing or halting processing of micro-operations by the processing circuitry; or
flushing or invalidating at least a portion of a data cache for caching data read in response to read micro-operations.

19. (canceled)

20. The apparatus according to claim 1, in which the cache comprises one of an instruction cache to cache instructions to be decoded to generate the micro-operations to be processed by the processing circuitry;
a micro-operation cache to cache micro-operations generated by decoding of instructions; or
a trace cache to cache sequences of micro-operations indicative of an order in which the micro-operations were previously processed by the processing circuitry.

21. (canceled)

22. (canceled)

23. A data processing method comprising:
processing micro-operations using processing circuitry supporting speculative processing of read micro-operations for reading data from a memory system;
storing in a cache the micro-operations or instructions decoded to generate the micro-operations; and
annotating at least one cached micro-operation or instruction in the cache with annotation information depending on analysis of whether a read micro-operation satisfies a speculative side-channel condition indicative of a risk of information leakage if the read micro-operation is processed speculatively; and
determining whether to trigger a speculative side-channel mitigation measure depending on the annotation information stored in the cache.
